(19) United States
(12) Patent Application Publication
(10) Pub. No.: US 2017/0018752 A1
(43) Pub. Date: Jan. 19, 2017

(54) METHOD OF MANUFACTURING SECONDARY BATTERY

(71) Applicant: SAMSUNG SDI CO., LTD., Yongin-si (KR)

(72) Inventors: Taegon Kim, Yongin-si (KR); Joonsup Kim, Yongin-si (KR); Inseop Byun, Yongin-si (KR); Youngchang Lim, Yongin-si (KR); Hyewon Kim, Yongin-si (KR); Jeawoan Lee, Yongin-si (KR); Wanuk Choi, Yongin-si (KR)

(21) Appl. No.: 15/197,546

(22) Filed: Jun. 29, 2016

(30) Foreign Application Priority Data
Jul. 16, 2015 (KR) 10-2015-0101108

(51) Int. Cl. H01M 2/26; B23K 20/10; B23K 20/00; H01M 10/04

(52) U.S. Cl. CPC H01M 2/263; H01M 10/0431; B23K 20/10; B23K 20/002

(57) ABSTRACT

A method of manufacturing a secondary battery includes: ultrasonic-welding a first electrode plate of an electrode assembly and a first electrode tab to each other by using a first horn including a first protruding tip; ultrasonic-welding a second electrode plate of the electrode assembly and a second electrode tab to each other by using a second horn including a second protruding tip, the second protruding tip having a positioning direction different from a positioning direction of the first protruding tip; and preparing the electrode assembly by arranging a separator between the first and second electrode plates.

### CROSS-REFERENCE TO RELATED APPLICATION

This application claims priority to and the benefit of Korean Patent Application No. 10-2015-0101108, filed on Jul. 16, 2015 in the Korean Intellectual Property Office, the disclosure of which is incorporated herein in its entirety by reference.

### BACKGROUND

1. Field

One or more exemplary embodiments of the present invention relate to a secondary battery and a method of manufacturing a secondary battery.

2. Description of the Related Art

Secondary batteries are used in various industrial fields, owing to their many advantages. For example, secondary batteries are widely used as energy sources for mobile electronic devices, such as digital cameras, cellular phones, and laptop computers, as well as energy sources for hybrid electric vehicles in order to solve problems, such as air pollution caused by internal combustion engine vehicles using fossil fuels, such as gasoline and diesel oil.

### SUMMARY

One or more exemplary embodiments of the present invention include a method of manufacturing a secondary battery in which first and second electrode tabs including different materials from each other are ultrasonic-welded under different process conditions (e.g., using different process characteristics) so as to reduce or prevent occurrences of the first and second electrode tabs being damaged and to ensure a high degree of coupling strength.

Additional aspects will be set forth, in part, in the description which follows and, in part, will be apparent from the description or may be learned by practice of the presented embodiments.

According to one or more exemplary embodiments of the present invention, a method of manufacturing a secondary battery includes: ultrasonic-welding a first electrode plate of an electrode assembly and a first electrode tab to each other by using a first horn including a first protruding tip; ultrasonic-welding a second electrode plate of the electrode assembly and a second electrode tab to each other by using a second horn including a second protruding tip, the second protruding tip having a positioning direction different from a positioning direction of the first protruding tip; and preparing the electrode assembly by arranging a separator between the first and second electrode plates.

The positioning direction of the first protruding tip may be substantially parallel to a vibrating direction of the ultrasonic-welding, and the positioning direction of the second protruding tip may form an angle with the vibrating direction of the ultrasonic-welding.

The positioning direction of the first protruding tip may be at an angle of about −5 degrees to about +5 degrees with respect to the vibrating direction, and the angle of the positioning direction of the second protruding tip with respect to the vibrating direction may be about 40 degrees to about 50 degrees.

The positioning direction of the first protruding tip may be at an angle of about 0 degrees with respect to the vibrating direction, and the angle of the positioning direction of the second protruding tip with respect to the vibrating direction may be about 45 degrees.

The first protruding tip and the second protruding tip may each have a polygonal cross-section, the positioning direction of the first protruding tip may be a facing direction of a side of the first protruding tip that makes a smallest angle with the vibrating direction, and the positioning direction of the second protruding tip may be a facing direction of a side of the second protruding tip that makes a smallest angle with the vibrating direction.

The first and second electrode tabs may include different materials from each other.

The first electrode tab may include aluminum, and the second electrode tab may include copper or nickel.

A number N of main vibrating contact sides of the first protruding tip may be less than a number M of main vibrating contact sides of the second protruding tip.

Each of the first and second protruding tips may have a quadrangular cross-section having four sides, the first protruding tip may have two main vibrating contact sides of the four sides thereof, and the second protruding tip may have four main vibrating contact sides of the four sides thereof.

Each of the first and second protruding tips may have a quadrangular pyramid shape having a quadrangular base.

The first horn may have a concave-convex surface on which a plurality of the first protruding tips are arranged, and the second horn may have a concave-convex surface on which a plurality of the second protruding tips are arranged.

An arrangement density of the first protruding tips on the first horn may be different from an arrangement density of the second protruding tips on the second horn.

The first protruding tips may be arranged having a first pitch, and the second protruding tips may be arranged having a second pitch, the first pitch being less than the second pitch.

The first protruding tips may have a different size from the second protruding tips.

The first protruding tips may be smaller than the second protruding tips.

### BRIEF DESCRIPTION OF THE DRAWINGS

These and/or other aspects will become apparent and more readily appreciated from the following description of exemplary embodiments of the present invention, taken in conjunction with the accompanying drawings in which:

FIG. 1 is an exploded perspective view illustrating a secondary battery according to an exemplary embodiment of the present invention;

FIG. 2 is a perspective view illustrating an unwound state of an electrode assembly depicted in FIG. 1;

FIG. 3 is a schematic view illustrating a first ultrasonic welding process for joining a first electrode tab to a first electrode plate;

FIG. 4 is a perspective view illustrating first protruding tips of a first horn depicted in FIG. 3;

FIGS. 5 and 6 are views illustrating a relationship between the vibrating direction of ultrasonic welding and a positioning direction of the first protruding tips;

FIG. 7 is a schematic view illustrating a second ultrasonic welding process for joining a second electrode tab to a second electrode plate;

FIG. 8 is a perspective view illustrating second protruding tips of a second horn depicted in FIG. 7;

FIGS. 9 and 10 are views illustrating a relationship between the vibrating direction of the ultrasonic welding and a positioning direction of the second protruding tips; and

FIGS. 11 and 12 are views illustrating arrangements of first and second protruding tips of first and second horns according to another exemplary embodiment of the present invention.

### DETAILED DESCRIPTION

Reference will now be made in detail to exemplary embodiments of the present invention, examples of which are illustrated in the accompanying drawings, wherein like reference numerals refer to like elements throughout. In this regard, the present exemplary embodiments may have different forms and should not be construed as being limited to the descriptions set forth herein. Accordingly, exemplary embodiments are merely described below, by referring to the figures, to explain aspects of the present description. As used herein, the term “and/or” includes any and all combinations of one or more of the associated listed elements and/or features. Expressions, such as “at least one of, ” when preceding a list of elements, modify the entire list of elements and do not modify the individual elements of the list.

It will be understood that when an element or layer is referred to as being “on,” “connected to,” or “coupled to” another element or layer, it may be directly on, connected, or coupled to the other element or layer or one or more intervening elements or layers may also be present. When an element is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. Further, the use of “may” when describing embodiments of the present invention relates to “one or more embodiments of the present invention.” Also, the term “exemplary” is intended to refer to an example or illustration. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments. In the figures, dimensions of the various elements, layers, etc. may be exaggerated for clarity of illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing particular example embodiments of the present invention and is not intended to be limiting of the described example embodiments of the present invention. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, a secondary battery and a method of manufacturing a secondary battery will be described with reference to the accompanying drawings, in which exemplary embodiments of the present invention are shown.

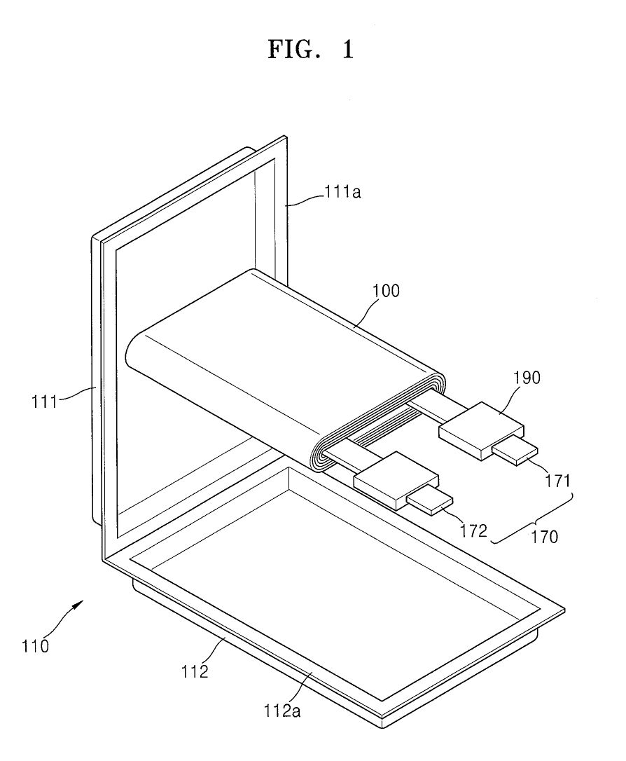

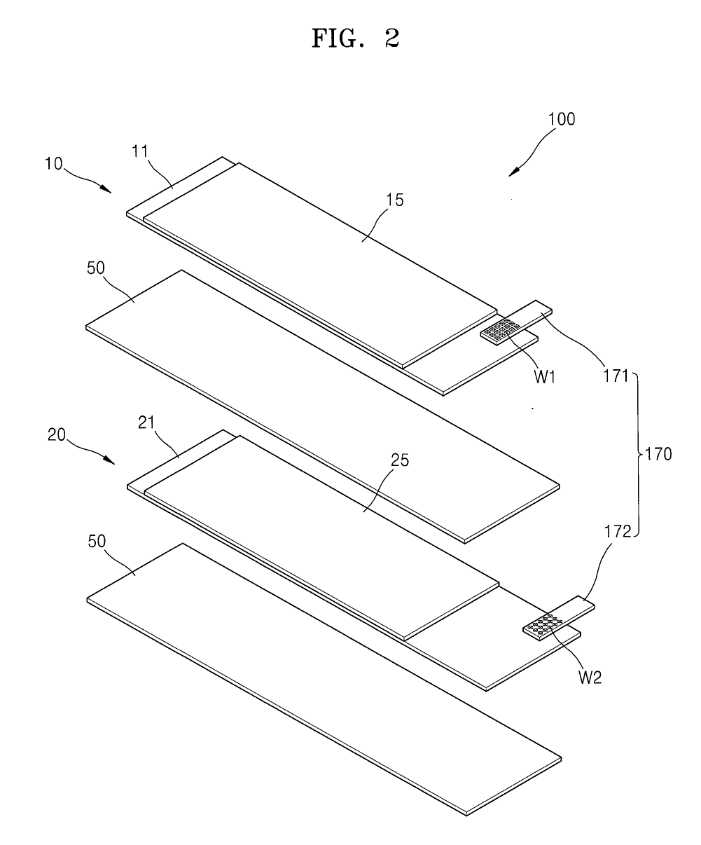

FIG. 1 is an exploded perspective view illustrating a secondary battery according to an exemplary embodiment of the present invention. FIG. 2 is a perspective view illustrating an unwound state of an electrode assembly depicted in FIG. 1.

Referring to FIG. 1, the secondary battery includes an electrode assembly 100, electrode tabs 170 electrically connected to the electrode assembly 100 and extending from the electrode assembly 100, and a case 110 accommodating the electrode assembly 100. The case 110 may include a first case 111 and a second case 112, and the first and second cases 111 and 112 may be joined together in mutually facing directions with the electrode assembly 100 being disposed therebetween. The first and second cases 111 and 112 may include (e.g., may be sealed to each other at) sealing parts 111a and 112a, and insulation tapes 190 may be attached to the electrode tabs 170 extending from the electrode assembly 100 so as to insulate the electrode tabs 170 from the sealing parts 111a and 112a.

Referring to FIG. 2, the electrode assembly 100 may be a jelly-roll type electrode assembly formed by disposing a separator 50 between first and second electrode plates 10 and 20 and winding the first and second electrode plates 10 and 20 and the separator 50 in the form of a roll. In another exemplary embodiment, the electrode assembly 100 may be a stacked type electrode assembly in which first and second electrode plates 10 and 20 are sequentially stacked in a state in which separators 50 are disposed between the first and second electrode plates 10 and 20. In this embodiment, the capacity of the secondary battery may be increased by increasing the number of electrode plates, such as first and second electrode plates 10 and 20. In the present disclosure, the first and second electrode plates 10 and 20 may be collectively referred to as electrode plates 10 and 20.

The electrode plates 10 and 20 may be formed by applying active materials to surfaces of electrode collectors 11 and 21. Thus, the electrode plates 10 and 20 may include the electrode collectors 11 and 21 and active material layers 15 and 25 formed on one or both surfaces of the electrode collectors 11 and 21, respectively. For example, the first electrode plate 10 may be a positive electrode plate including a positive electrode collector 11 and a positive electrode active material layer 15 formed on at least one surface of the positive electrode collector 11. Similarly, the second electrode plate 20 may be a negative electrode plate including a negative electrode collector 21 and a negative electrode active material layer 25 formed on at least one surface of the negative electrode collector 21.

Non-coated portions of the electrode plates 10 and 20, on which the active material layers are not formed, may be located at edge portions of the electrode plates 10 and 20. The electrode tabs 170 may be electrically connected to the non-coated portions. For example, the electrode tabs 170 may include first and second electrode tabs 171 and 172 respectively electrically connected to the non-coated portions of the first and second electrode plates 10 and 20. In the present disclosure, the first and second electrode tabs 171 and 172 may be collectively referred to as electrode tabs 170. As will be further described later, the electrode tabs 170 may be coupled to the non-coated portions by an ultrasonic welding method.

The electrode tabs 170 may include a metallic material having a high degree of conductivity. For example, the first electrode tab 171 may include aluminum, and the second electrode tab 172 may include copper or nickel.

The electrode tabs 170 may be electrically connected to the electrode plates 10 and 20 at weld zones W1 and W2. The weld zones W1 and W2 may be formed by ultrasonic welding (e.g., the electrode tabs 170 may be coupled to the electrode plates 10 and 20 by ultrasonic welding). For example, in an ultrasonic welding process, the electrode plates 10 and 20 and the electrode tabs 170 may be disposed to overlap each other as base metals to be welded to each other and may be pressed between a horn and an anvil of a welding machine. In this state, high frequency ultrasonic vibrations may be applied so as to weld the electrode plates 10 and 20 and the electrode tabs 170 by vibration energy, such as frictional heat.

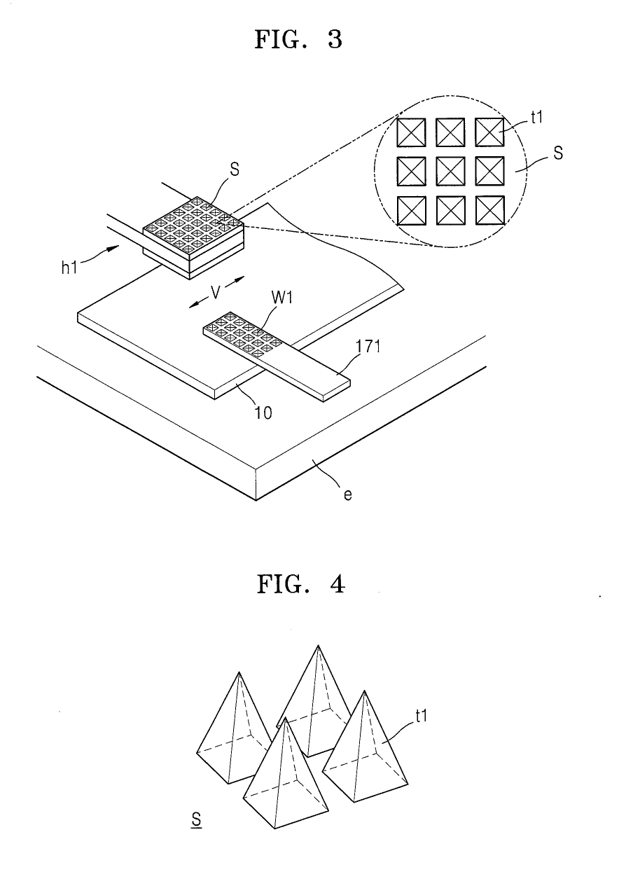

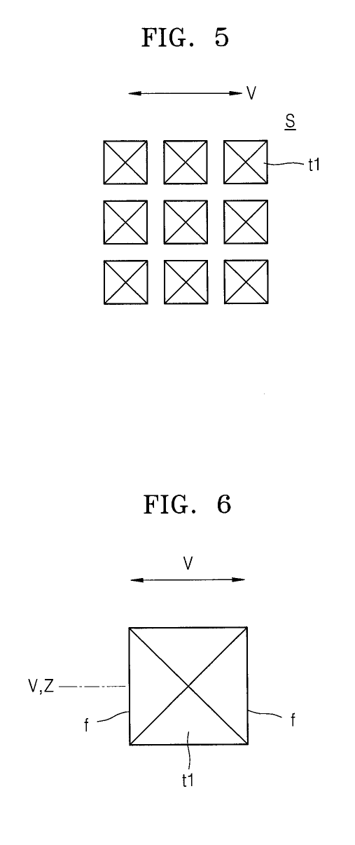

FIG. 3 is a schematic view illustrating a first ultrasonic welding process for joining the first electrode tab 171 to the first electrode plate 10. FIG. 4 is a perspective view illustrating a first horn h1 and first protruding tips t1. FIGS. 5 and 6 are views illustrating a relationship between a vibrating direction V and a positioning direction Z of the first protruding tips t1.

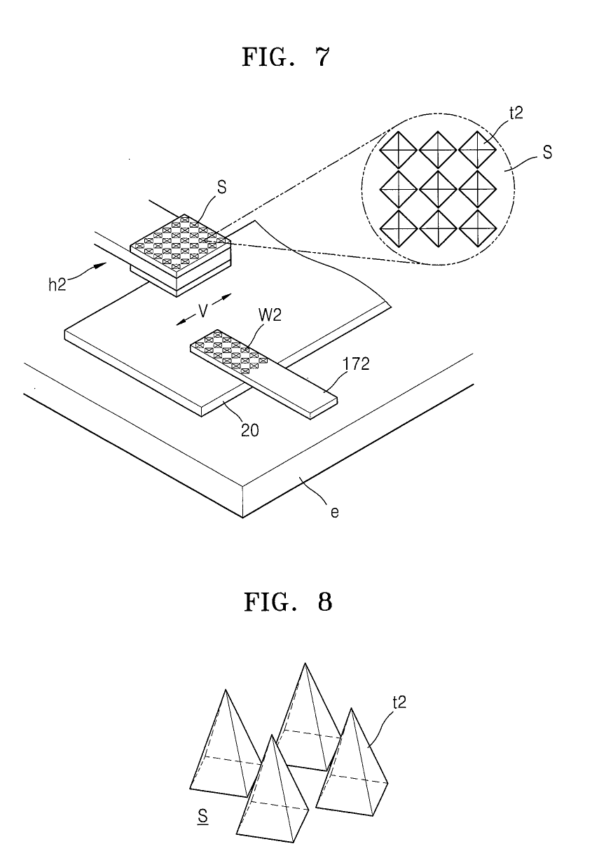

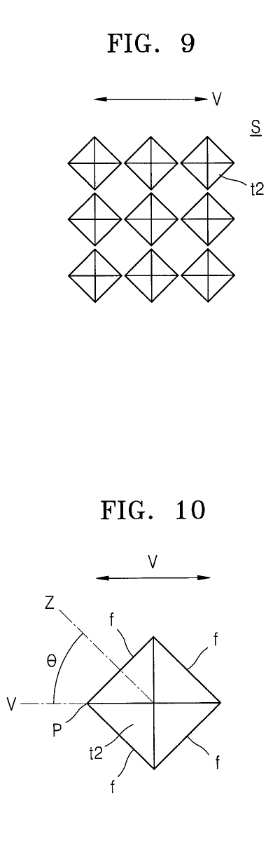

FIG. 7 is a schematic view illustrating a second ultrasonic welding process for joining the second electrode tab 172 to the second electrode plate 20. FIG. 8 is a perspective view illustrating a second horn h2 and second protruding tips t2. FIGS. 9 and 10 are views illustrating a relationship between the vibrating direction V and a positioning direction Z of the second protruding tips t2.

Referring to FIG. 3, in the first ultrasonic welding process, the first electrode plate 10 and the first electrode tab 171 (e.g., base metals 10 and 171 to be welded to each other) are disposed between the first horn h1 having a concave-convex surface S and an anvil (e) having a support surface facing the first horn h1, and in a state in which the first electrode plate 10 and the first electrode tab 171 are pressed between the first horn h1 and the anvil (e), ultrasonic vibrations are applied to the first electrode plate 10 and the first electrode tab 171. As shown in FIG. 3, the first horn h1 may include the first protruding tips t1 protruding toward the anvil (e). The first protruding tips t1 may be regularly arranged (e.g., arranged in a regular or repeating pattern) to form the concave-convex surface S of the first horn h1.

Referring to FIG. 4, each of the first protruding tips t1 may have a poly-pyramid shape. In an exemplary embodiment, the first protruding tips t1 may have a quadrangular pyramid shape having a quadrangular cross-section. However, the exemplary embodiments of the present invention are not limited thereto. For example, the first protruding tips t1 may have a different poly-pyramid shape, such as a triangular pyramid shape having a triangular cross-section or a pentagonal pyramid shape having a pentagonal cross-section.

For example, the cross-sectional shape of the first protruding tips t1 may be the same or substantially the same as the shape of bottom surfaces (e.g., the surfaces opposite to apexes) of the first protruding tips t1 facing the anvil (e). A cross-section of each of the first protruding tips t1 may have vibrating contact sides through which vibrations are applied to the first electrode tab 171 (e.g., sides of each of the first protruding tips t1 may be vibrating contact sides through which vibrations are applied to the first electrode tab 171). For example, in a state in which the apexes of the first protruding tips t1 are stuck into (e.g., pressed into or pressed against) the first electrode tab 171, the first electrode tab 171 may be vibrated by the vibrating contact sides of the first protruding tips t1.

Referring to FIGS. 5 and 6, each side of each of the first protruding tips t1 may not function as vibrating contact sides (f). For example, in one embodiment, each of the four sides of the quadrangular cross-section of each of the first protruding tips t1 may be vibrating contact sides (f) or, in other embodiments, only some of the four sides may be vibrating contact sides (f). This may vary according to an angle between the positioning direction Z of the first protruding tips t1 and the vibrating direction V of the ultrasonic welding. For example, in one embodiment, each of the four sides of the quadrangular cross-section of each of the first protruding tips t1 may function as vibrating contact sides (f) or, in other embodiments, only two of the four sides may function as vibrating contact sides (f).

Vibrating contact sides (f) (e.g., the sides of the first protruding tips t1 that function as vibrating contact sides (f)) are determined according to an angle between the positioning direction Z of the first protruding tips t1 and the vibrating direction V of the ultrasonic welding, and these vibrating contact sides (f) may be understood as being main vibrating contact sides (f) in consideration of tolerance. For example, there may be a difference between a set angle (e.g., a designed angle) and an actual angle (e.g., an angle as manufactured), and thus, the following description will be presented using the concept of main vibrating contact sides (f). For example, two sides of the quadrangular cross-section of each of the first protruding tips t1 that have a relatively high contact pressure may function as main vibrating contact sides (f).

In a state in which the first protruding tips t1 are pushed against the first electrode tab 171, the first protruding tips t1 may apply ultrasonic vibrations to the first electrode tab 171. When the ultrasonic vibrations are applied to the first electrode tab 171, main vibrating contact sides (f) of the first protruding tips t1 may vary according to the positioning direction Z of the first protruding tips t1 and the vibrating direction V of the ultrasonic welding. For example, main vibrating contact sides (f) of the first protruding tips t1 may vary according to the angle between the positioning direction Z of the first protruding tips t1 and the vibrating direction V of the ultrasonic welding, and the characteristics of the ultrasonic welding may vary according to the main vibrating contact sides (f).

Referring to FIG. 7, in the second ultrasonic welding process, the second electrode plate 20 and the second electrode tab 172 (e.g., base metals 20 and 172 to be welded to each other) may be disposed between the second horn h2 having a concave-convex surface S and an anvil (e) having a support surface facing the second horn h2, and in a state in which the second electrode plate 20 and the second electrode tab 172 are pressed between the second horn h2 and the anvil (e), ultrasonic vibrations may be applied to the second electrode plate 20 and the second electrode tab 172. As shown in FIG. 7, the second horn h2 may include the second protruding tips t2 protruding toward the anvil (e). The second protruding tips t2 may be regularly arranged (e.g., arranged in a regular or repeating pattern) so as to form the concave-convex surface S of the second horn h2.

Referring to FIG. 8, each of the second protruding tips t2 may have a poly-pyramid shape. In an exemplary embodiment, the second protruding tips t2 may have a quadrangular pyramid shape having a quadrangular cross-section. However, the exemplary embodiments of the present invention are not limited thereto. For example, the second protruding tips t2 may have a different poly-pyramid shape, such as a triangular pyramid shape having a triangular cross-section or a pentagonal pyramid shape having a pentagonal cross-section.

For example, the cross-sectional shape of the second protruding tips t2 may be the same or substantially the same as the shape of bottom surfaces (e.g., surface opposite to apexes) of the second protruding tips t2 facing the anvil (e). Each of the second protruding tips t2 may have vibrating contact sides through which vibrations are applied to the second electrode tab 172. For example, in a state in which the apexes of the second protruding tips t2 are stuck into (e.g., pressed into or pressed against) the second electrode tab 172, the second electrode tab 172 may be vibrated by contact sides (e.g., cross-sectional sides) of the second protruding tips t2.

Referring to FIGS. 9 and 10, each side of the cross-section of each of the second protruding tips t2 may function as vibrating contact sides (f). This may vary according to an angle between the positioning direction Z of the second protruding tips t2 and the vibrating direction V of the ultrasonic welding. For example, in one embodiment, each the four sides of the quadrangular cross-section of each of the second protruding tips t2 may function as vibrating contact sides (f) or, in other embodiments, only two of the four sides may function as vibrating contact sides (f). Vibrating contact sides (f) vary according to the angle between the positioning direction Z of the second protruding tips t2 and the vibrating direction V of the ultrasonic welding, and the vibrating contact sides (f) may be understood as main vibrating contact sides (f) in consideration of tolerance. For example, there may be a difference between a set angle and an actual angle, and thus, the following description will be presented using the concept of main vibrating contact sides (f). For example, each of the four sides of the quadrangular cross-section of each of the second protruding tips t2 may function as main vibrating contact sides (f).

In a state in which the second protruding tips t2 are pushed against the second electrode tab 172, the second protruding tips t2 may apply ultrasonic vibrations to the second electrode tab 172. As the second protruding tips t2 apply ultrasonic vibrations to the second electrode tab 172, main vibrating contact sides (f) of the second protruding tips t2 may vary according to the positioning direction Z of the second protruding tips t2 and the vibrating direction V of the ultrasonic welding. For example, main vibrating contact sides (f) of the second protruding tips t2 may vary according to the angle between the positioning direction Z of the second protruding tips t2 and the vibrating direction V of the ultrasonic welding, and the characteristics of ultrasonic welding may vary according to the main vibrating contact sides (f). In the present disclosure, the first and second protruding tips t1 and t2 may be collectively referred to as protruding tips t1 and t2.

Referring to FIGS. 6 and 10, different main vibrating contact sides (f) are used when the first and second electrode tabs 171 and 172 are ultrasonic-welded. For example, the angle between the positioning direction Z of the first protruding tips t1 and the vibrating direction V of the ultrasonic welding may be different from the angle between the positioning direction Z of the second protruding tips t2 and the vibrating direction V of the ultrasonic welding.

In the following description, the same vibrating direction V of the ultrasonic welding may be used for (e.g., is set for) the first and second electrode tabs 171 and 172, and the positioning directions Z of the protruding tips t1 and t2 will be further described based on the same vibrating direction V. According to an exemplary embodiment, when the first and second electrode tabs 171 and 172 are ultrasonic-welded, the protruding tips t1 and t2, that is, cross-sectional edges of the protruding tips t1 and t2, are in (e.g., are arranged in or face) different directions with respect to the vibrating direction V.

In the present disclosure, a direction normal to a side of the cross-section of one of the protruding tips t1 or t2 is defined as a facing direction of the side of the cross-section. For example, when the protruding tips t1 and t2 have the quadrangular cross-sectional shape, the facing direction of cross-sectional sides of the protruding tips t1 or t2 may be defined as the positioning direction Z of the protruding tips t1 or t2. For example, one of the facing directions of the cross-sectional sides of the protruding tips t1 or t2 which is closest to the vibrating direction V of the ultrasonic welding, that is, which makes the smallest angle with the vibrating direction V, may be defined as the positioning direction Z of the protruding tips t1 or t2.

Referring to FIG. 6, when the first electrode tab 171 is ultrasonic-welded, the positioning direction Z of the first protruding tips t1 may be about 0 degrees with respect to the vibrating direction V of the ultrasonic welding. For example, the positioning direction Z of the first protruding tips t1 may be parallel to the vibrating direction V. In this embodiment, the angle between the positioning direction Z of the first protruding tips t1 and the vibrating direction V of ultrasonic welding may be (e.g., may be set to be) within a range of about −5 degrees to about +5 degrees in consideration of tolerance.

Referring to FIG. 10, when the second electrode tab 172 is ultrasonic-welded, the positioning direction Z of the second protruding tips t2 may be about 45 degrees with respect to the vibrating direction V of the ultrasonic welding. For example, the positioning direction Z of the second protruding tips t2 may not be parallel to (e.g., may form an angle with) the vibrating direction V of the ultrasonic welding. In this embodiment, the angle between the positioning direction Z of the second protruding tips t2 and the vibrating direction V of the ultrasonic welding may be set to be within a range of about 40 degrees to about 50 degrees in consideration of tolerance. When the first and second electrode tabs 171 and 172 are ultrasonic-welded, the positioning direction Z of the protruding tips t1 and t2 is set with respect to the vibrating direction V. For example, the vibrating direction V is set as an axis being at 0 degrees.

The first and second electrode tabs 171 and 172 may include different materials from each other. The first and second electrode tabs 171 and 172 respectively extend from the first and second electrode plates 10 and 20, and the first and second electrode tabs 171 and 172 may be formed of materials that are the same as or are similar to materials used to form the first and second electrode plates 10 and 20, respectively, to ensure coupling strength between the first and second electrode tabs 171 and 172 and the first and second electrode plates 10 and 20.

Process conditions of an ultrasonic welding process for the first and second electrode tabs 171 and 172 may be determined according to the properties of materials of the first and second electrode tabs 171 and 172. For example, when the first electrode tab 171 is formed of aluminum, the mechanical strength of the first electrode tab 171 may be relatively low, and thus, the first electrode tab 171 may be easily torn during an ultrasonic welding process. For example, when the first electrode tab 171 is formed of a material having a relatively low strength, an ultrasonic welding process may be performed which may reduce damage to the first electrode tab 171 in exchange for relatively reduced coupling strength between the first electrode tab 171 and the first electrode plate 10 (e.g., the ultrasonic welding process may be focused primarily on reducing damage to the first electrode tab 171 rather than the coupling strength between the first electrode tab 171 and the first electrode plate 10).

In this embodiment, when the first electrode tab 171 is ultrasonic-welded, the positioning direction Z of the first protruding tips t1 may be (e.g., may be set to be) parallel to the vibrating direction V of the ultrasonic welding (refer to FIG. 6). The main vibrating contact sides (f) of the first protruding tips t1 may include two sides (e.g., first and second vibrating contact sides (f)) of which the facing directions are parallel to the vibrating direction V. The other two sides of which the facing directions are perpendicular to the vibrating direction V may not be (e.g., may not function as) vibrating contact sides (f).

The first and second vibrating contact sides (f) may vibrate the first electrode tab 171 in the vibrating direction V. In this embodiment, because the first and second vibrating contact sides (f) do not have a sharp portion, the first electrode tab 171 may not be damaged or may be less damaged. Because only two sides of the four sides of each of cross sections of the first protruding tips t1 function as main vibrating contact sides (f), welding strength may be reduced to some degree. However, the first electrode tab 171 may be less damaged. For example, because the main vibrating contact sides (f) do not have a sharp portion, the first electrode tab 171 may not be torn.

Different than the first electrode tab 171, the second electrode tab 172 may be formed of copper or nickel. In this embodiment, although the second electrode tab 172 may have a sufficient degree of mechanical strength (e.g., may be sufficiently strong), it may be difficult to ensure a sufficient degree of coupling strength between the second electrode tab 172 and the second electrode plate 20 by ultrasonic-welding. For example, the second electrode tab 172 formed of a material having a relatively high degree of strength may be ultrasonic-welded in a way such that the coupling strength between the second electrode tab 172 and the second electrode plate 20 is increased.

For example, when the second electrode tab 172 is ultrasonic-welded, the positioning direction Z of the second protruding tips t2 may be (e.g., may be set at) an angle with respect to (e.g., may form an angle with or may be set to be not parallel with) the vibrating direction V of the ultrasonic welding. In this embodiment, each of the four sides of each of the cross-sections of the second protruding tips t2 may function as main vibrating contact sides (f).

For example, the four main vibrating contact sides (f) may vibrate the second electrode tab 172 in the vibrating direction V. In this embodiment, because each of the four cross-sectional sides of each of the second protruding tips t2 function as main vibrating contact sides (f), welding strength may be increased, and thus, the coupling strength between the second electrode tab 172 and the second electrode plate 20 may be improved. Because the second electrode tab 172 is formed of a material having relatively high mechanical strength, although four main vibrating contact sides (f) are used to increase the coupling strength between the second electrode tab 172 and the second electrode plate 20, the second electrode tab 172 may not be damaged or may be less damaged.

The four main vibrating contact sides (f) include sharp corners (p) (e.g., the second electrode tab 172 may be vibrated in contact with sharp corners (p)). Because the second electrode tab 172 is pressed by the sharp corners (p) in the vibrating direction V of the ultrasonic welding, a considerably greater pressure may be applied to the second electrode tab 172. For example, relatively high contact pressure may be applied to very small areas of the second electrode tab 172 by the sharp corners (P). However, because the second electrode tab 172 is formed of the material having relatively high mechanical strength, the second electrode tab 172 may not be damaged or may be less damaged even though relatively high contact pressure is applied to the second electrode tab 172. In addition, the coupling strength between the second electrode tab 172 and the second electrode plate 20 may be increased.

When the second electrode tab 172 is ultrasonic-welded, the positioning direction Z of the second protruding tips t2 may be (e.g., may be set to be) offset with respect to (e.g., may not be parallel to) the vibrating direction V of the ultrasonic welding. In this embodiment, each of the four cross-sectional sides of each of the second protruding tip t2 may function as a main vibrating contact side (f).

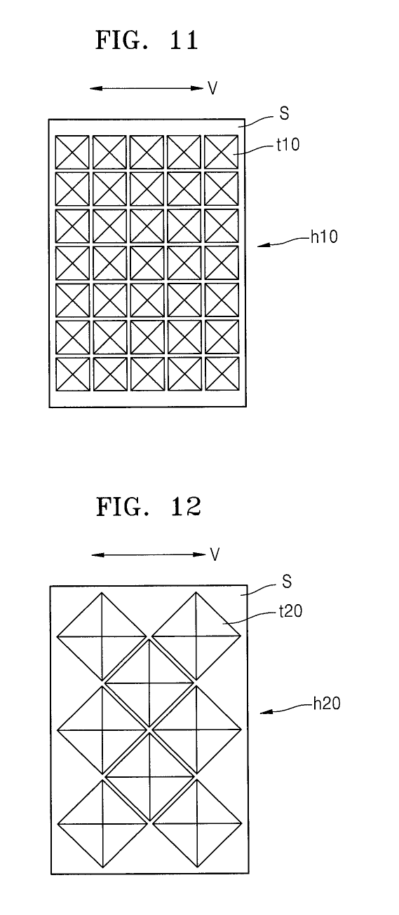

FIGS. 11 and 12 are views illustrating arrangements of first and second protruding tips t10 and t20 of first and second horns h10 and h20, respectively, according to another exemplary embodiment.

Referring to FIGS. 11 and 12, the first and second horns h10 and h20 may be used for ultrasonic welding of the first and second electrode tabs 171 and 172, and the first and second horns h10 and h20 may include concave-convex surfaces S on which the first and second protruding tips t10 and t20 are arranged, respectively. The first and second protruding tips t10 and t20 arranged on the concave-convex surfaces S of the first and second horns h10 and h20 may have different sizes and/or pitches from each other.

For example, the first protruding tips t10 may be densely arranged at relatively small intervals, and the second protruding tips t20 may be sparsely arranged at relatively large intervals. The size of each of the first protruding tips t10 may be smaller than the size of each of the second protruding tips t20. For example, the first protruding tips t10 having a relatively small size may be densely arranged, and the second protruding tips t20 having a relatively large size may be sparsely arranged.

The first and second electrode tabs 171 and 172 may be formed of different materials from each other. When the first electrode tab 171 is formed of aluminum having relatively low mechanical strength, an ultrasonic welding process performed on the first electrode tab 171 may focus on a method which may not damage or may only minimally damage the first electrode tab 171. In this embodiment, the first protruding tips t10 may have a relatively small size and may be densely arranged. For example, because the first protruding tips t1 are relatively small, the first electrode tab 171 may be less damaged when being vibrated by the first protruding tips t10. However, because the first protruding tips t10 are densely arranged, the first electrode tab 171 may be welded with a sufficient degree of welding strength.

When the second electrode tab 172 is formed of copper or nickel having relatively high mechanical strength, an ultrasonic welding process performed on the second electrode tab 172 may focus on coupling strength rather than on reducing damage to the second electrode tab 172. In this embodiment, the second protruding tips t20 may have a relatively large size and may be sparsely arranged. For example, because the second protruding tips t20 have a relatively large size, a sufficient degree of welding strength may be ensured when the second protruding tips t20 are not densely arranged. For example, the second protruding tips t20 may be arranged in a relatively sparse pattern by taking manufacturing costs into consideration. For example, when the second protruding tips t20 have a relatively large size, the second protruding tips t20 may be inserted into the second electrode tab 172 to a relatively deep depth with a relatively large contact area between the second protruding tips t20 and the second electrode tab 172. Therefore, a relatively large force may be applied to the second electrode tab 172, thereby ensuring a high degree of welding strength.

Referring to FIGS. 11 and 12, the positioning directions Z of the first and second protruding tips t10 and t20 relative to the vibrating direction V of the ultrasonic welding are different from each other. These orientations and arrangements are the same or are substantially the same as those described above, and thus, repeated description thereof may be omitted here.

Referring to FIGS. 11 and 12, both the size and pitch of the first protruding tips t10 are different from the size and pitch of the second protruding tips t20. However, in other exemplary embodiments, only the size or the pitch of the first protruding tips t10 may be different from the size or the pitch of the second protruding tips t20.

Hereinafter, a method of manufacturing a secondary battery will be described according to an exemplary embodiment.

Referring to FIGS. 1 and 2, the method may include: preparing an electrode assembly 100 including first and second electrode plates 10 and 20 and a separator 50 disposed between the first and second electrode plates 10 and 20; welding the first electrode plate 10 and a first electrode tab 171 to each other through a first ultrasonic welding process; and welding the second electrode plate 20 and a second electrode tab 172 to each other through a second ultrasonic welding process.

Referring to FIGS. 3 and 7, in the first ultrasonic welding process, the first electrode tab 171 is welded to the first electrode plate 10 using a first horn h1 including first protruding tips t1, and in the second ultrasonic welding process, the second electrode tab 172 is welded to the second electrode plate 20 using a second horn h2 including second protruding tips t2. The first horn h1 may include a concave-convex surface S on which the first protruding tips t1 are arranged, and the second horn h2 may include a concave-convex surface S on which the second protruding tips t2 are arranged. Referring to FIGS. 4 and 8, the first and second protruding tips t1 and t2 may each have a quadrangular pyramid shape having a quadrangular base.

Referring to FIGS. 6 and 10, in the first and second ultrasonic welding processes, the positioning directions Z of the first and second protruding tips t1 and t2 relative to a vibrating direction V of ultrasonic welding are different from each other. For example, the positioning direction Z of the first protruding tips t1 may be substantially parallel to the vibrating direction V of the ultrasonic welding, and the positioning direction Z of the second protruding tips t2 may form an angle with (e.g., may not be parallel to) the vibrating direction V of the ultrasonic welding.

The first and second electrode tabs 171 and 172 may include different materials. For example, the first electrode tab 171 may include aluminum, and the second electrode tab 172 may include copper or nickel.

Process conditions of the first and second ultrasonic welding processes may be determined according to the properties of the materials of the first and second electrode tabs 171 and 172. For example, when the first electrode tab 171 is formed of aluminum, the mechanical strength of the first electrode tab 171 may be relatively low, and thus, the first electrode tab 171 may be easily torn during an ultrasonic welding process. For example, when the first electrode tab 171 is formed of a relatively low strength material, the first ultrasonic welding process may be performed such that reducing damage to the first electrode tab 171 is a primary concern rather than the coupling strength between the first electrode tab 171 and the first electrode plate 10.

Different from the first electrode tab 171, the second electrode tab 172 may be formed of copper or nickel. In this embodiment, although the second electrode tab 172 may have a sufficient degree of mechanical strength, it may be difficult to ensure sufficient coupling strength between the second electrode tab 172 and the second electrode plate 20. For example, the second electrode tab 172 formed of the material having a relatively high degree of strength may be ultrasonic-welded such that the coupling strength between the second electrode tab 172 and the second electrode plate 20 is increased.

To this end, an angle between the positioning direction Z of the first protruding tips t1 and the vibrating direction V of the ultrasonic welding may be within (e.g., may be set to be within) a range of about −5 degrees to about +5 degrees, and an angle between the positioning direction Z of the second protruding tips t2 and the vibrating direction V of the ultrasonic welding may be within (e.g., may be set to be within) a range of about 40 degrees to about 50 degrees. For example, the angle between the positioning direction Z of the first protruding tips t1 and the vibrating direction V of the ultrasonic welding may be about 0 degrees, and the angle between the positioning direction Z of the second protruding tips t2 and the vibrating direction V of the ultrasonic welding may be about 45 degrees.

The positioning direction Z of the first protruding tips t1 may refer to one of the facing directions of the sides of the polygonal cross-sections of each of the first protruding tips t1 that makes the smallest angle with the vibrating direction V of the ultrasonic welding, and the positioning direction Z of the second protruding tips t2 may refer to one of the facing directions of the sides of the polygonal cross-sections of each of the second protruding tips t2 that makes the smallest angle with the vibrating direction V of the ultrasonic welding.

For example, a number N of main vibrating contact sides (f) of each of the first protruding tips t1 (e.g., of each of the polygonal cross-sections of the first protruding tips t1) may be less than a number M of main vibrating contact sides (f) of each of the second protruding tips t2 (e.g., of each of the polygonal cross-sections of the second protruding tips t2) (N<M). For example, according to the angle between the vibrating direction V and the positioning direction Z of the protruding tips t1 and t2, all four sides or only two sides of each of the quadrangular cross-sections of the protruding tips t1 and t2 may function as main vibrating contact sides (f). In the first ultrasonic welding process in which the first electrode tab 171 is ultrasonic-welded in which mechanical damage to the first electrode tab 171 is reduced, the first protruding tips t1 may each have two main vibrating contact sides (f) (N=2) (refer to FIG. 6). In the second ultrasonic welding process in which the second electrode tab 172 is ultrasonic-welded in which welding strength is increased, the second protruding tips t2 may each have four main vibrating contact sides (f) (M=4) (refer to FIG. 10).

Referring to FIGS. 11 and 12, in another method of manufacturing a secondary battery, first and second electrode tabs 171 and 172 may be ultrasonic-welded by using a first horn h10 including first protruding tips t10 and a second horn h20 including second protruding tips t20 having an arrangement density different from an arrangement density of the first protruding tips t10. For example, the first protruding tips t10 may be arranged with a relatively small pitch, and the second protruding tips t20 may be arranged with a relatively large pitch.

The first protruding tips t10 of the first horn h10 and the second protruding tips t20 of the second horn h20 having different sizes from each other may be used when the first and second electrode tabs 171 and 172 are ultrasonic-welded. For example, the first protruding tips t10 may be smaller than the second protruding tips t20.

The first and second electrode tabs 171 and 172 may be formed of different materials from each other. When the first electrode tab 171 is formed of aluminum having relatively low mechanical strength, an ultrasonic welding process may be performed on the first electrode tab 171 using a method in which damage to the first electrode tab 171 is reduced. To this end, the first protruding tips t10 may have a relatively small size and may be densely arranged.

When the second electrode tab 172 is formed of copper or nickel having relatively high mechanical strength, an ultrasonic welding process may be performed on the second electrode tab 172 in which coupling strength rather than reducing damage to the second electrode tab 172 is the primary focus. To this end, the second protruding tips t20 may have a relatively large size and may be sparsely arranged. For example, because the second protruding tips t20 have a relatively large size, a sufficient degree of welding strength may be ensured when the second protruding tips t20 are not densely arranged. For example, the second protruding tips t20 may be arranged in a relatively sparse pattern by taking manufacturing costs into consideration.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims and their equivalents.

What is claimed is:

1. A method of manufacturing a secondary battery, the method comprising:
ultrasonic-welding a first electrode plate of an electrode assembly and a first electrode tab to each other by using a first horn comprising a first protruding tip;
ultrasonic-welding a second electrode plate of the electrode assembly and a second electrode tab to each other by using a second horn comprising a second protruding tip, the second protruding tip having a positioning direction different from a positioning direction of the first protruding tip; and
preparing the electrode assembly by arranging a separator between the first and second electrode plates.

2. The method of claim 1, wherein the positioning direction of the first protruding tip is substantially parallel to a vibrating direction of the ultrasonic-welding, and
the positioning direction of the second protruding tip is forms an angle with the vibrating direction of the ultrasonic-welding.

3. The method of claim 2, wherein the positioning direction of the first protruding tip is at an angle of about −5 degrees to about +5 degrees with respect to the vibrating direction, and
the angle of the positioning direction of the second protruding tip with respect to the vibrating direction is about 40 degrees to about 50 degrees.

4. The method of claim 2, wherein the positioning direction of the first protruding tip is at an angle of about 0 degrees with respect to the vibrating direction, and
the angle of the positioning direction of the second protruding tip with respect to the vibrating direction is about 45 degrees.

5. The method of claim 1, wherein the first protruding tip and the second protruding tip each have a polygonal cross-section,
the positioning direction of the first protruding tip is a facing direction of a side of the first protruding tip that makes a smallest angle with a vibrating direction, and
the positioning direction of the second protruding tip is a facing direction of a side of the second protruding tip that makes a smallest angle with the vibrating direction.

6. The method of claim 1, wherein the first and second electrode tabs comprise different materials from each other.

7. The method of claim 6, wherein the first electrode tab comprises aluminum, and
the second electrode tab comprises copper or nickel.

8. The method of claim 1, wherein a number N of main vibrating contact sides of the first protruding tip is less than a number M of main vibrating contact sides of the second protruding tip.

9. The method of claim 8, wherein each of the first and second protruding tips have a quadrangular cross-section having four sides,
the first protruding tip has two main vibrating contact sides of the four sides thereof, and
the second protruding tip four main vibrating contact sides of the four sides thereof.

10. The method of claim 1, wherein each of the first and second protruding tips has a quadrangular pyramid shape having a quadrangular base.

11. The method of claim 1, wherein the first horn has a concave-convex surface on which a plurality of the first protruding tips are arranged, and
the second horn has a concave-convex surface on which a plurality of the second protruding tips are arranged.

12. The method of claim 11, wherein an arrangement density of the first protruding tips on the first horn is different from an arrangement density of the second protruding tips on the second horn.

13. The method of claim 12, wherein the first protruding tips are arranged having a first pitch, and
the second protruding tips are arranged having a second pitch, the first pitch being less than the second pitch.

14. The method of claim 11, wherein the first protruding tips have a different size from the second protruding tips.

15. The method of claim 14, wherein the first protruding tips are smaller than the second protruding tips.
